(19) United States
(12) Patent Application Publication
(10) Pub. No.: US 2026/0073723 A1
(43) Pub. Date: Mar. 12, 2026

(54) SYSTEMS AND METHODS FOR LEVERAGING COMPLETION LOGIC

(71) Applicant: Capital One Services, LLC, McLean, VA (US)

(72) Inventors: Joshua EDWARDS, Philadelphia, PA (US); Michael MOSSOBA, Great Falls, VA (US); Tyler MAIMAN, Melville, NY (US)

(73) Assignee: Capital One Services, LLC, McLean, VA (US)

(21) Appl. No.: 18/826,791

(22) Filed: Sep. 6, 2024

(51) Int. Cl. G06V 30/262; G06V 30/14; G06V 30/18; G06V 30/19

(52) U.S. Cl. CPC G06V 30/274; G06V 30/1444; G06V 30/18; G06V 30/191; G06V 2201/09

(57) ABSTRACT

Techniques for leveraging completion logic may include: obtaining image data via a user device; detecting, via optical character recognition (OCR), an indeterminate alphanumeric sequence in the image data, the indeterminate alphanumeric sequence including at least one indeterminate character; predicting at least one value for the at least one indeterminate character based on one or more of a predetermined syntax of the alphanumeric sequence or content of the image data separate from the alphanumeric sequence; and determining a complete alphanumeric sequence based on the at least one predicted value and the indeterminate alphanumeric sequence.

### TECHNICAL FIELD

Various embodiments of this disclosure relate generally to image analysis and character recognition techniques for disambiguating uncertain data or completing sequences or patterns, and, more particularly, to systems and methods for leveraging logic underlying an alphanumeric sequence or information providing context to the sequence to predict unknown or uncertain values in the sequence.

### BACKGROUND

Many tasks rely on accurate automated recognition of alphanumeric sequences. In an example, accurate recognition of a license plate number is important for correct identification of a vehicle by a traffic camera. In another example, accurate optical recognition of a credit card number on a credit card, e.g., when a card strip scanner or chip reader is not available, is important for correct card validation or execution of an interaction.

However, conventional techniques generally rely on Optical Character Recognition (OCR). When OCR is not able to identify a particular character, e.g., due to bad lighting, an oblique image perspective, poor image quality, etc., the recognition process generally fails, and would need to be repeated. Such failures may reduce user trust in the accuracy of such approaches, e.g., due to limited information as to why such a process may have failed. Moreover, a failure of an OCR process may not only complicate a task, but may act as a chilling effect on further attempts.

This disclosure is directed to addressing challenges such as one or more of those referenced above. The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY OF THE DISCLOSURE

According to certain aspects of the disclosure, methods and systems are disclosed for leveraging logic underlying an alphanumeric sequence or additional information surrounding the sequence to predict unknown or uncertain values in the sequence.

In one aspect, an exemplary embodiment of a computer-implemented method for leveraging completion logic may include: obtaining image data via a user device; detecting, via optical character recognition (OCR), an indeterminate alphanumeric sequence in the image data, the indeterminate alphanumeric sequence including at least one indeterminate character; predicting at least one value for the at least one indeterminate character based on one or more of a predetermined syntax of the alphanumeric sequence or content of the image data separate from the alphanumeric sequence; and determining a complete alphanumeric sequence based on the at least one predicted value and the indeterminate alphanumeric sequence.

In another aspect, an exemplary embodiment of a system for leveraging completion logic may include: at least one memory storing instructions; an imaging device; and at least one processor operatively connected to the imaging device and at least one memory and configured to execute the instructions to perform operations. The operations may include: obtaining image data via the imaging device; detecting, via optical character recognition (OCR), an indeterminate alphanumeric sequence in the image data, the indeterminate alphanumeric sequence including at least one indeterminate character; predicting at least one value for the at least one indeterminate character based on one or more of a predetermined syntax of the alphanumeric sequence or content of the image data separate from the alphanumeric sequence; and determining a complete alphanumeric sequence based on the at least one predicted value and the indeterminate alphanumeric sequence.

In a further aspect, an exemplary embodiment of a computer-implemented method for leveraging completion logic may include: obtaining image data via a user device; detecting, via optical character recognition (OCR), an indeterminate alphanumeric sequence in the image data, the indeterminate alphanumeric sequence including at least one indeterminate character; determining, based on the OCR, confidence scores of a plurality of values for the at least one indeterminate character; in response to none of the confidence scores meeting a predetermined threshold: determining an identifying feature from the image data that is separate from the indeterminate alphanumeric sequence; obtaining an identity-specific predetermined syntax associated with the identifying feature; and predicting at least one value for the at least one indeterminate character based on the identity-specific predetermined syntax; and determining a complete alphanumeric sequence based on the at least one predicted value and the indeterminate alphanumeric sequence.

In an additional aspect, an exemplary embodiment of a computer-implemented method for leveraging completion logic may include: obtaining imaging data from a user device; detecting, via optical character recognition (OCR), an indeterminate alphanumeric sequence in the imaging data, the indeterminate alphanumeric sequence having at least one three-dimensional alphanumeric character with an indeterminate value; obtaining reflective pattern data of the alphanumeric sequence; predicting at least one value for the at least one three-dimensional alphanumeric character based on the reflective pattern data; and determining a complete alphanumeric sequence based on the at least one predicted value of the at least one three-dimensional alphanumeric character.

In a further aspect, an exemplary embodiment of a system for leveraging completion logic may include: at least one memory storing instructions; an imaging device; and at least one processor operatively connected to the at least one memory and the imaging device, and configured to execute the instructions to perform operations. The operations may include: obtaining imaging data from the imaging device; detecting, via optical character recognition (OCR), an indeterminate alphanumeric sequence in the imaging data, the indeterminate alphanumeric sequence having at least one three-dimensional alphanumeric character with an indeterminate value; obtaining reflective pattern data of the alphanumeric sequence; predicting at least one value for the at least one three-dimensional alphanumeric character based on the reflective pattern data; and determining a complete alphanumeric sequence based on the at least one predicted value of the at least one three-dimensional alphanumeric character.

In another aspect, an exemplary embodiment of a computer-implemented method for leveraging completion logic may include: obtaining imaging data from a user device; detecting, via optical character recognition (OCR), an indeterminate alphanumeric sequence in the imaging data, the indeterminate alphanumeric sequence having at least one three-dimensional alphanumeric character with an indeterminate value; determining a plurality of possible values for the at least one three-dimensional alphanumeric character via the OCR; causing the user device to activate a lighting device: and obtaining reflective pattern data of the alphanumeric sequence via the user device, with the lighting device in an active state; predicting at least one value for the at least one three-dimensional alphanumeric character by selecting from amongst the plurality of possible values based on the reflective pattern data; and determining a complete alphanumeric sequence based on the at least one predicted value of the at least one three-dimensional alphanumeric character.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts an exemplary embodiment of an environment for leveraging completion logic, according to one or more embodiments.

FIG. 2 illustrates an exemplary embodiment of a process for leveraging completion logic, according to one or more embodiments.

FIG. 3 illustrates another exemplary process for leveraging completion logic, according to one or more embodiments.

FIG. 4 illustrated a simplified functional block diagram of a computer system usable with various embodiments.

### DETAILED DESCRIPTION OF EMBODIMENTS

According to certain aspects of the disclosure, methods and systems are disclosed for leveraging logic underlying an alphanumeric sequence or additional information surrounding the sequence to predict unknown or uncertain values in the sequence, e.g., identifying characters in a sequence that are ambiguously identified via Optical Character Recognition (OCR). OCR has been used for many tasks. However, OCR is generally not fault tolerant; a failure by OCR to identify a character generally results in incomplete or inaccurate rendition of an OCR'd sequence. For example, conventional techniques may not leverage logic underlying a sequence, context information, multiple OCR passes or multiple modalities. Accordingly, improvements in technology relating to character recognition are needed.

As will be discussed in more detail below, in various embodiments, systems and methods are described for using machine-learning to leverage one or more modalities of data, such as reflection pattern data, perspective data, etc. By training a machine-learning model, e.g., via supervised or semi-supervised learning, to learn associations between training reflection data, perspective data, etc. for a sequence to be identified and training identification data of the sequence, the trained machine-learning model may be usable to leverage reflection data in order to identify a character that may otherwise be ambiguously identified using OCR.

Reference to any particular activity is provided in this disclosure only for convenience and not intended to limit the disclosure. A person of ordinary skill in the art would recognize that the concepts underlying the disclosed devices and methods may be utilized in any suitable activity. The disclosure may be understood with reference to the following description and the appended drawings, wherein like elements are referred to with the same reference numerals.

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features, as claimed.

In this disclosure, the term “based on” means “based at least in part on.” The singular forms “a,” “an,” and “the” include plural referents unless the context dictates otherwise. The term “exemplary” is used in the sense of “example” rather than “ideal.” The terms “comprises,” “comprising,” “includes,” “including,” or other variations thereof, are intended to cover a non-exclusive inclusion such that a process, method, or product that comprises a list of elements does not necessarily include only those elements, but may include other elements not expressly listed or inherent to such a process, method, article, or apparatus. The term “or” is used disjunctively, such that “at least one of A or B” includes, (A), (B), (A and A), (A and B), etc. Relative terms, such as, “substantially” and “generally,” are used to indicate a possible variation of ±10% of a stated or understood value.

It will also be understood that, although the terms first, second, third, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Terms like “provider,” “merchant,” “vendor,” or the like generally encompass an entity or person involved in providing, selling, or renting items to persons such as a seller, dealer, renter, merchant, vendor, or the like, as well as an agent or intermediary of such an entity or person. An “item” generally encompasses a good, service, or the like having ownership or other rights that may be transferred. As used herein, terms like “user” or “customer” generally encompasses any person or entity that may desire information, resolution of an issue, purchase of a product, or engage in any other type of interaction with a provider. An “interaction” generally encompasses an act or action involving transfer of an item between a provider and a user. The term “browser extension” may be used interchangeably with other terms like “program,” “electronic application,” or the like, and generally encompasses software that is configured to interact with, modify, override, supplement, or operate in conjunction with other software or devices.

As used herein, a “machine-learning model” generally encompasses instructions, data, or a model configured to receive input, and apply one or more of a weight, bias, classification, or analysis on the input to generate an output. The output may include, for example, a classification of the input, an analysis based on the input, a design, process, prediction, or recommendation associated with the input, or any other suitable type of output. A machine-learning model is generally trained using training data, e.g., experiential data or samples of input data, which are fed into the model in order to establish, tune, or modify one or more aspects of the model, e.g., the weights, biases, criteria for forming classifications or clusters, or the like. Aspects of a machine-learning model may operate on an input linearly, in parallel, via a network (e.g., a neural network), or via any suitable configuration. By virtue of such training, a machine-learning model is converted from an un-trained and un-specific model to a model that is unique to and specifically configured for the particular purpose for which it is trained. In an example, training of a machine-learning model is analogous to a method of production in which the article produced is the trained model having unique characteristics by virtue of its particular training. Moreover, the result of training a machine-learning model using particular training data and for a particular purpose results in a technical solution to an inherently technical problem.

The execution of the machine-learning model may include deployment of one or more machine learning techniques, such as linear regression, logistical regression, random forest, gradient boosted machine (GBM), deep learning, or a deep neural network. Supervised or unsupervised training may be employed. For example, supervised learning may include providing training data and labels corresponding to the training data, e.g., as ground truth. Unsupervised approaches may include clustering, classification or the like. K-means clustering or K-Nearest Neighbors may also be used, which may be supervised or unsupervised. Combinations of K-Nearest Neighbors and an unsupervised cluster technique may also be used. Any suitable type of training may be used, e.g., stochastic, gradient boosted, random seeded, recursive, epoch or batch-based, etc.

A user may engage in a task that includes an automated character recognition step. For instance, the user may be operating an electronic application on their mobile device to conduct an interaction for an item with a provider. The electronic application may enable the user to complete the interaction using a payment card, e.g., a credit card. In some instances, the electronic application may request verification that the user is in physical possession of the payment card, e.g., by recognition of the payment card in an image captured by the user's device. In some instances, the user may prefer to capture interaction information from the payment card itself, e.g., rather than having to manually enter such information into the electronic application. In some instances, the electronic application may interface with a further application usable to obtain or verify payment card information such as in the foregoing examples. Conventionally, an imaging device such as a camera or the like may be used to capture an image of the payment card, and an OCR process is applied to the captured image in order to identify information from the payment card, e.g., a card number, expiration date, security code, etc. Generally, an OCR process includes an imaging analysis of individual characters, e.g., a comparison of image data with shapes or parameters known or learned to correspond to a particular character or sequence of characters. OCR'd information may be used, e.g., via the electronic application, to verify or complete the interaction.

However, there are a wide variety of reasons why OCR'd information may be inaccurate or incomplete. Sub-optimal lighting, view angle, motion, etc. may result in an image with insufficient detail or artifacts that obstruct or inhibit the OCR process. Moreover, while OCR is generally applied to flat surfaces, e.g., text printed onto a flat medium, some tasks involve three-dimensional text of surfaces. For instance, some payment cards utilize embossed text, e.g., alphanumeric characters that are raised from/embedded into a surface of the medium. Such three-dimensional structure, e.g., when captured by a camera for OCR, may result in an inaccurate or incomplete identification of the OCR'd information.

In an exemplary use case, completion logic, context information, or an additional modality of data may be used along with an OCR process, e.g., in order to more accurately identify a character or characters that may otherwise be ambiguous or unidentified using conventional OCR. In an example, an OCR process applied to image data may result in a prediction or estimation of an alphanumeric sequence (e.g., a payment card number) that is indeterminate. For instance, the estimated sequence may include one or more characters that could not be accurately identified by the OCR process. While a conventional OCR process might fail, or merely report inaccurate data, leveraging information such as the foregoing may enable accurate identification of otherwise ambiguous or missing characters.

In one example, the information being OCR'd may have an underlying or predetermined syntax, e.g., a logic that may be used to complete an incomplete or ambiguous sequence. For example, some payment cards begin with certain particular characters, group characters into predetermined sub-sets, or adhere to a mathematical, combinatorial, or organizational criteria. Such syntax may be used to identify the ambiguous character. For instance, an OCR process performed on an employee ID card may return a sequence of “?234,” in which the “?” character refers to a character that is ambiguous or could not be identified. A predetermined syntax for ID cards may require, for example, that ID numbers begin with a “1”, that the sum of all digits is ten or less, that ID numbers only have three digits, etc. Such syntax may be used to determine the identity of the “?” character, or that there is no such character. In another example, a predetermined syntax may be used to reduce the possibility space, e.g., the range of possible values for an ambiguous character. For instance, the OCR process above may be unable to select between a “1” and a “7” for the “?” character. The predetermined syntax may be used to eliminate the “7” as a possibility, decrease a predicted likeliness or confidence in the identification being a “7” or the like, and thus reduce the possible likely options down, e.g., to a best likelihood or a last remaining option.

In another example, context information may be used to complete an incomplete or ambiguous sequence. For instance, context information for the payment card also captured in the image data, e.g., a logo of the provider or the like, a format of an expiration date, a background coloring of the card, etc. may be usable to determine which predetermined syntax applies to the information being OCR'd. In another instance, additional images captured by the camera may provide context. For example, multiple perspectives of the payment card, multiple images focusing on different portions of the payment card, etc., may provide information that may be combined or synthesized into a more accurate OCR process. In an example, rather than capturing an image, the user's device may be operated to capture multiple images or a video from which multiple images may be extracted. In some instances, some perspectives may provide better data than others, e.g., due to lighting, reflections, view angle of three-dimensional structures, etc.

In a further example, a modality of data other than conventional imaging data may be used. For instance, reflection data may be obtained, e.g., with or without additional illumination. In some embodiments, an edge detection process may be applied to the reflection data, e.g., to identify three-dimensional structures or reflections thereof. Reflection data may be evaluated against known reflection patterns of different characters, e.g., via an image comparison, a machine-learning model, etc. The evaluation may be used to identify a character, replace or modify a confidence or likelihood of identification, or the like.

It should also be understood that multiple techniques, such as the above, may be used in combination. For example, multiple perspective or video of a target may be evaluated for reflection data. Syntax and reflection data may be used in combination to determine likely candidates for an ambiguous character, etc.

While several of the examples above involve identifying alphanumeric characters, it should be understood that techniques according to this disclosure may be adapted to any suitable type of identification or computer vision. It should also be understood that the examples above are illustrative only. The techniques and technologies of this disclosure may be adapted to any suitable activity. In an example, techniques similar to the above may be adapted to facial recognition, object identification, or the like.

Moreover, techniques such as the foregoing may be leveraged for various purposes. In an example, context and predetermined syntax of an alphanumeric sequence may be usable for validation. For instance, many card providers do not provide cards with an expiration date further away than five years, and so an expiration data contrary to such context may indicate an invalid card. In another example, virtual payment cards may not be assigned an expiration date. If a card number returns to a virtual card, but an expiration data was present in the image data, such presence may be indicative of an invalid card. In a further example, a technique such as the above may be used in conjunction with manual entry. For instance, the electronic application may obtain a card number through a technique such as the above, but only enter it for an interaction upon a user manually entering a portion of the number.

Presented below are various aspects of machine learning techniques that may be adapted to recognizing ambiguous characters, e.g., using completion logic, context information, or additional modality data. As will be discussed in more detail below, machine learning techniques adapted to evaluating OCR data or other information such as context, syntax, an additional modality of data etc., may include one or more aspects according to this disclosure, e.g., a particular selection of training data, a particular training process for the machine-learning model, operation of a particular device suitable for use with the trained machine-learning model, operation of the machine-learning model in conjunction with particular data, modification of such particular data by the machine-learning model, etc., or other aspects that may be apparent to one of ordinary skill in the art based on this disclosure.

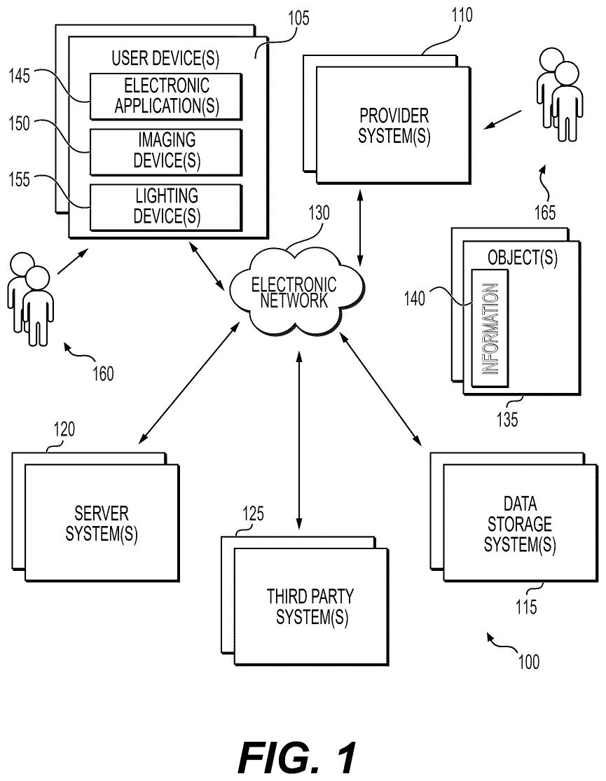

FIG. 1 depicts an exemplary environment 100 that may be utilized with techniques presented herein. One or more user device(s) 105, one or more provider system(s) 110, one or more data storage system(s) 115, one or more server system(s) 120, and one or more third party system(s) 125 may communicate across an electronic network 130. An object 135 may include information 140, e.g., alphanumeric text that may be desirably captured and parsed. As will be discussed in further detail below, the user device 105 may include one or more electronic application(s) 145, at least one imaging device 150, and a lighting device 155. The user device 105 may be associated with a user 160, e.g., a user associated with performing an interaction or other task involving the information 140, e.g., with a provider 165 associated with the provider system 110.

In some embodiments, the components of the environment 100 are associated with a common entity, e.g., a provider 165, a financial institution such as a payment card issuer or processor, or the like. In some embodiments, one or more of the components of the environment is associated with a different entity than another. The systems and devices of the environment 100 may communicate in any arrangement. As will be discussed herein, systems or devices of the environment 100 may communicate in order to one or more of generate, train, distribute, or use an electronic application, e.g., with a machine-learning model, to recognize and identify characters that are ambiguous via OCR, among other activities.

The user device 105 may be configured to enable the user 160 to access or interact with other systems in the environment 100. For example, the user device 105 may be a computer system such as, for example, a desktop computer, a mobile device, a tablet, etc. In some embodiments, the user device 105 may include one or more electronic application(s) 145, e.g., a program, plugin, browser extension, etc., installed on a memory of the user device 105. In some embodiments, the electronic application(s) may be associated with one or more of the other components in the environment 100. For example, the electronic application(s) may include one or more of a web browser, an e-commerce platform, an image analysis tool, a payment application, etc.

The imaging device 150 of the user device 105 may include, for example, one or more cameras, photo-sensors, or the like. In some embodiments, multiple imaging devices 150 are usable to obtain three-dimensional images. In some embodiments, an imaging device or multiple imaging devices may be usable to obtain different types of images, e.g., via visible light, infrared, depth, etc. The lighting device 155 may include any suitable type of light, e.g., a flashlight or flash integrated with or associated with the imaging device 150 or otherwise included on the user device 105. It should be understood however, that in some embodiments, the imaging device 150 or the lighting device may be included in a device or devices separate from the user device 105.

The user device 105 may include a first electronic application 145, e.g., a client-side instance of an e-commerce application, an identification verification application, etc., or a web browser operable to visit an online resource with similar functionality. Such an application or resource may include, for example, an interactive interface for receiving user information, selections, or interactions. In an example, some actions of the user 160 or the first electronic application 145 may require or benefit from information obtainable from a physical article such as the object 135, e.g., identifying information, account information, confirmation that the user 160 is in physical possession of the object 135, etc. As will be discussed in further detail below, the first electronic application may be configured to operate in conjunction with other elements in order to obtain such information. For instance, in some embodiments, the first electronic application 145 may operate or receive data captured via the imaging device 150.

In some embodiments, the first electronic application 145 may operate in conjunction with a second electronic application. For instance, in some embodiments, a first electronic application may be associated with a provider 165, and may operate in conjunction with a second electronic application associated with a server system 120 or a third party system 125, such as a payment card processor, identity verification service, etc. Such electronic applications 145 on the user device 105 may communicate via any suitable means such as, for example, an Application Programming Interface (API), via network 130, etc.

In some embodiments, the first electronic application 145 or the second electronic application includes one or more models or algorithms configured to extract information such as the information discussed above from image data of an object 135. As discussed in further detail below, the model or algorithm may be obtained from the server system 125, or the like. The information, once extracted, may be provided to and used by the first electronic application. The model or algorithm may include, for example, one or more of an OCR process, a machine-learning model, etc. Such models may, for example, be configured to generate an identification of a character or characters given input imaging data, generate a score or confidence level for such an identification, or the like, or may be used for other suitable purposes such as image analysis, feature extraction, content identification or association, etc.

In some embodiments, the first electronic application 145 or the second electronic application includes information regarding one or more predetermined syntax for alphanumeric sequences. In some embodiments, the first electronic application 145 or the second electronic application may include information associating one or more predetermined syntax with a specific identity, e.g., a particular issuer of a credit card. In some embodiments, the first electronic application 145 or the second electronic application includes information associating image content with one or more predetermined syntax. For instance, a company name or logo of a particular issuer of a credit card may be associated with a particular predetermined syntax.

The provider system 110 may include a server, an electronic data system, computer-readable memory such as a hard drive, flash drive, disk, etc. In some embodiments, the provider system 110 includes or interacts with an API for exchanging data to other systems, e.g., one or more of the other components of the environment. In some embodiments, the provider system 110 hosts or provides data for hosting a server-side instance of first electronic application 145.

The data storage system 115 may include a server, an electronic data system, computer-readable memory such as a hard drive, flash drive, disk, etc. In some embodiments, the data storage system 115 includes or interacts with an API for exchanging data to other systems, e.g., one or more of the other components of the environment. In some embodiments, the data storage system 115 stores user data such as account information, historical interaction information, image data such as images of one or more objects 135 or reference images of characters for model training, syntax data for alphanumeric sequences, context data for objects 135, or any other suitable type and kind of data.

The server system 120 may include one or more machine-learning models or instructions or data usable to generate or train a machine-learning model. As discussed in further detail below, the server system 120 may one or more of generate, store, train, or use a model or algorithm configured to determine or extract information from image data. Such model or algorithm may be distributed to and used by, for example, the first or second electronic application operating on the user device 105.

In some embodiments, the model includes one or more image processing algorithms, such as an OCR process. In some embodiments, the model includes one or more syntax process configured to operate in conjunction with the OCR process, e.g., to apply predetermined knowledge regarding a syntax to information to be captured to results generated by the OCR process. In some embodiments, the model includes one or more image feature extraction process, e.g., a process configured to extract one or more context characteristics present in image data such as colors, logos, symbols, shapes, characters, etc.

In some embodiments, the server system 120 may include one or more machine-learning models or instructions associated with the model, e.g., instructions for generating a machine-learning model, training the machine-learning model, using the machine-learning model etc. The server system 120 may include instructions for retrieving training image data and training character identifications associated with the training image data, e.g., from the data storage system 115. The server system 120 may include instructions for training a machine-learning model, e.g., by applying training data such as the foregoing to a base model. Training image data may include, for example, image data of training objects, reflection pattern data of the training objects, context data of the training objects, syntax data associated with the training objects, etc. As used herein, image data generally encompasses data resulting from image capture using an imaging device. As used herein, reflection pattern data refers to image data in which reflection of light from a three-dimensional structure causes a visible reflection on surroundings. In some instances, a reflection pattern may be extracted from an image. In some instances, an image used to capture a reflection pattern is taken under particular conditions configured to highlight or promote the incidence of reflections, e.g., from a particular perspective or under particular lighting conditions in which reflections of the three-dimensional structure will be exemplified. In some instances, e.g., when training or using a model, multiple images or reflection patterns of a single character sample may be used, e.g., images or patterns for the same sample at different perspectives or lighting conditions. In some instances, one or more images or patterns may be extracted from a video, a three-dimensional image, or the like. Training character identifications may identify characters or sequences of characters present in the image data of the training objects.

In some embodiments, the machine-learning model includes an OCR model. In an example, a model trained for OCR may be modified, e.g., via a transfer learning process, to further train the model on additional parameters such as syntax, reflection patterns, context, etc.

Models generated or trained by the server system 120 may be provided or distributed to the first or second electronic application 145, e.g., periodically, upon the model being updated, on request, etc.

Generally, a machine-learning model includes a set of variables, e.g., nodes, neurons, filters, etc., that are tuned, e.g., weighted or biased, to different values via the application of training data. In supervised learning, e.g., where a ground truth is known for the training data provided, training may proceed by feeding a sample of training data into a model with variables set at initialized values, e.g., at random, based on Gaussian noise, a pre-trained model, or the like. The output may be compared with the ground truth to determine an error, which may then be back-propagated through the model to adjust the values of the variable. In unsupervised learning, patterns, correlations, or clusters of input samples may be used to determine one or more metrics or features of the samples usable to differentiate between related subsets of the samples. In semi-supervised learning, unsupervised and supervised approaches may be combined.

Training may be conducted in any suitable manner, e.g., in batches, and may include any suitable training methodology, e.g., stochastic or non-stochastic gradient descent, gradient boosting, random forest, etc. In some embodiments, a portion of the training data may be withheld during training or used to validate the trained machine-learning model, e.g., compare the output of the trained model with the ground truth for that portion of the training data to evaluate an accuracy of the trained model. The training of the machine-learning model may be configured to cause the machine-learning model to learn associations between image data, context data, syntax data, etc., and identifications of particular alphanumeric characters, such that the trained machine-learning model is configured to determine an output alphanumeric character or sequence identification in response to the input image, context, syntax, or reflection pattern data or the like based on the learned associations.

In various embodiments, the variables of a machine-learning model may be interrelated in any suitable arrangement in order to generate the output. For example, in some embodiments, the machine-learning model may include image-processing architecture that is configured to identify, isolate, or extract features, geometry, and or structure in one or more of the medical imaging data or the non-optical in vivo image data. For example, the machine-learning model may include one or more convolutional neural network (“CNN”) configured to identify features in the image data, and may include further architecture, e.g., a connected layer, neural network, etc., configured to determine a relationship between the identified features in order to determine a location or pattern in the data.

In some instances, different samples of training data or input data may not be independent. For example, syntax, e.g., an order or pattern in a sequence of alphanumeric characters defined or limited by an underlying logic, may be associated with other aspects of an object 135. In an example, payment cards associated with a particular provider 165 may be a particular color, such that the color is usable to identify which syntax applies. In another example, reflection patterns for a particular character may be influenced by the structure or reflection patterns of other nearby characters. Thus, in some embodiments, the machine-learning model may be configured to account for or determine relationships between multiple samples.

For example, in some embodiments, the machine-learning model of the server system 120 may include a Recurrent Neural Network (“RNN”). Generally, RNNs are a class of feed-forward neural networks that may be well adapted to processing a sequence of inputs. In some embodiments, the machine-learning model may include a Long Short Term Memory (“LSTM”) model or Sequence to Sequence (“Seq2Seq”) model. An LSTM model may be configured to generate an output from a sample that takes at least some previous samples or outputs into account. A Seq2Seq model may be configured to, for example, receive a sequence of non-optical in vivo images as input, and generate a sequence of locations, e.g., a path, in the medical imaging data as output.

Various features may be included or used with any suitable machine learning model. For instance, a model may be configured to receive and or determine a relative positioning of data or portions of data in samples (e.g., position of words in a sentence, location of pixels in an image, etc.), and use such positions as a portion of the input to the model. In another instance, a model configured to utilize attention may be configured to weigh, determine, or the like how different samples or portions of samples impact the output of the model, and may incorporate such data into the training process. An example of a model that utilizes information on relative positioning and attention is a transformer model. One implementation incorporating a transformer is a large language model. Transformers and other suitable models have been used for multi-modal input, e.g., a model that is configured to use and process input of different modalities (a combination of or selection from one or more of text, audio, video, structured or unstructured data, etc.). In an example, a transformer model may be trained on multi-model input such as image data, reflection pattern data, context data, syntax data, etc., to identify characters or sequences of characters of an object for which such data is provided.

Any suitable type of machine learning model or combination of machine learning models may be used. Operations conducted by one model in some embodiments may be distributed amongst a plurality of models in other embodiments, or vice versa.

The third party system 125 may include a server, an electronic data system, computer-readable memory such as a hard drive, flash drive, disk, etc. In some embodiments, the third party system 125 includes or interacts with an API for exchanging data to other systems, e.g., one or more of the other components of the environment. In some embodiments, the third party system 125 stores user data such as account information, historical interaction information, etc. In some embodiments, the third party system 125 is associated with a financial institution, payment processor, payment card issuer, or the like. In an example, a provider 165 may utilize the third party system 125 to process an interaction of a user 160 to obtain an item, e.g., by processing information obtained from an object 135.

In various embodiments, the electronic network 130 may be a wide area network (“WAN”), a local area network (“LAN”), personal area network (“PAN”), or the like. In some embodiments, electronic network 130 includes the Internet, and information and data provided between various systems occurs online. “Online” may mean connecting to or accessing source data or information from a location remote from other devices or networks coupled to the Internet. Alternatively, “online” may refer to connecting or accessing an electronic network (wired or wireless) via a mobile communications network or device. The Internet is a worldwide system of computer networks—a network of networks in which a party at one computer or other device connected to the network can obtain information from any other computer and communicate with parties of other computers or devices. The most widely used part of the Internet is the World Wide Web (often-abbreviated “WWW” or called “the Web”). A “website page” generally encompasses a location, data store, or the like that is, for example, hosted or operated by a computer system so as to be accessible online, and that may include data configured to cause a program such as a web browser to perform operations such as send, receive, or process data, generate a visual display or an interactive interface, or the like.

The object 135 may include, for example, a payment card, an identification badge, an item package, paper media such as a check, ticket, book, note, or the like, or any other suitable object that might include information 140 such as that discussed in the examples above or as described in more detail below.

The information 140 may include, for example, one or more alphanumeric characters or sequence of characters. Such character(s) may represent or be associated with, for example, an account number, a payment number, an identification number, or any other suitable information. In some embodiments, the character(s) may be printed, painted, or otherwise suitably applied onto the object. In some embodiments, the character(s) may include three-dimensional structure, e.g., an embossing, raising, or indenting of the character(s) relative to a surface of the object 135.

The character(s) may be arranged, limited, sorted, organized, or applied according to a predetermined syntax. A syntax may include, for example, criteria for an ordering of one or more characters, how multiple characters are grouped (e.g., in sets of 3, 4, or the like), particular inclusion of characters (e.g., a requirement for a leading “6”, a trailing “X”, that no “7”s are adjacent to “3”s , etc.), that a sequence of characters adheres to or applies a particular algorithm (e.g., a hash, a checksum, a Luhn algorithm, or the like). In some instances, a particular syntax may be associated with a particular object issuer, a particular type of object, a particular account, a particular user or category of user, etc.

The information 140 may include, for example, context for the character(s). Context may include, for example, a logo of an entity such as an issuer of the object 135, a name of the issuer or the user 160, a photo of the user 160, a coloring of the object 135, a shape of the object 135, or other parameters or information indicated by one or more characters such as an expiration data, security code, issuance date, or any other suitable text-based information.

In some instances, the context information of an object 135 is usable to determine a particular syntax that applies to the object 135. In some instances, an association between syntax and context is predetermined or entered manually. In some instances, such relationship may be learned, e.g., via training of a machine-learning model or application of statistical analysis or the like to sequences of characters and context information of objects 135.

Although depicted as separate components in FIG. 1, it should be understood that a component or portion of a component in the environment 100 may, in some embodiments, be integrated with or incorporated into one or more other components. For example, a portion of the server system 120 may be integrated into the user device 105 or the like. In another example, third party system 125 may be integrated into the provider system 110. In some embodiments, operations or aspects of one or more of the components discussed above may be distributed amongst one or more other components. Any suitable arrangement or integration of the various systems and devices of the environment 100 may be used.

Further aspects of various models, e.g., a machine-learning model or how it may be utilized to recognize characters that would otherwise be ambiguous under conventional OCR are discussed in further detail in the methods below.

In the following methods, various acts may be described as performed or executed by a component from FIG. 1, such as the server system 120, the third party system 125, the provider system 110, or the first or second electronic application 145 operating on the user device 105, or components thereof. However, it should be understood that in various embodiments, various components of the environment 100 discussed above may execute instructions or perform acts including the acts discussed below. An act performed by a device may be considered to be performed by a processor, actuator, or the like associated with that device. Further, it should be understood that in various embodiments, various steps may be added, omitted, or rearranged in any suitable manner.

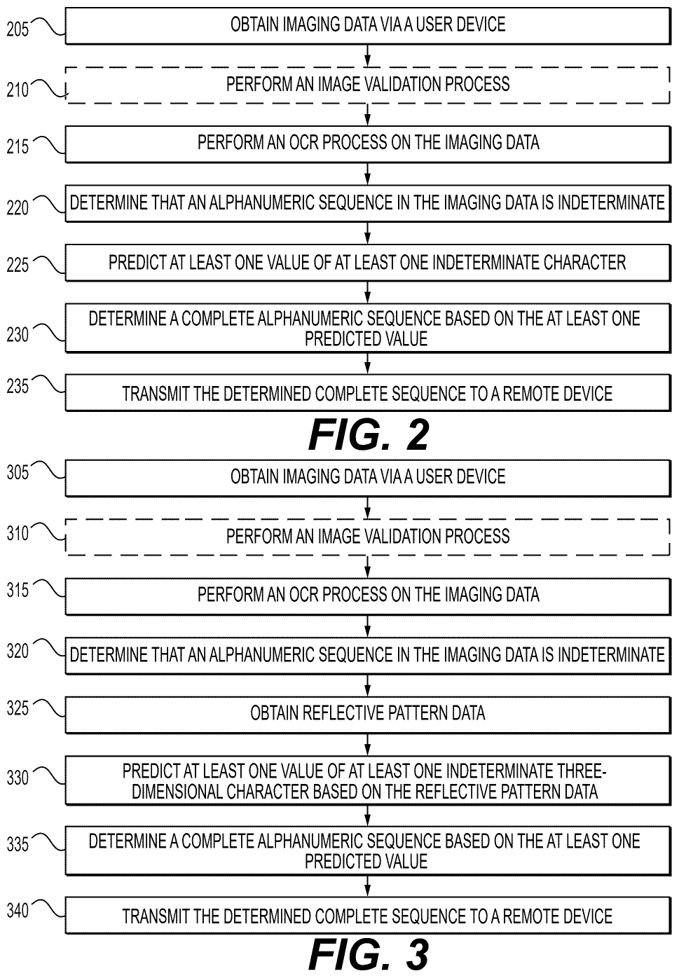

FIG. 2 illustrates an exemplary process for leveraging completion logic, e.g., to identify an ambiguous character such as in the various examples discussed above. A user 160 may be engaged in an activity associated with capturing information 140 from an object 135. For example, the user 160 may be conducting an interaction with a provider 165, e.g., via a first electronic application 145 operating on a user device 105, to obtain an item from the provider 165. The provider 165, via the first electronic application 145, may request capture of the information 140, e.g., to use the information 140 to complete the interaction, to verify possession of the object 135 by the user 160, etc. In some instances, the first electronic application 145 may engage an imaging device 150 of the user device 105. In some instances, the first electronic application 145 may engage a second electronic application 145.

At step 205, imaging data may be obtained via the user device 105, e.g., via operation of the imaging device 150. The imaging data may include, for example, one or more of an image, a video, or the like, that includes at least a portion of the object 135. In an example, the imaging data includes multiple images or a video from which one or more images may be extracted. The following operations may be performed on one or many images, or the like.

Optionally, at step 210, the user device 105, e.g., the first or second electronic application 145 or the like, may perform an image validation process. For example, the user device 105 may perform image analysis in order to determine whether the object 135 is present in the imaging data, whether a portion of the object 135 is obscured, too far or too close to the imaging device 150, or otherwise unsuitable for analysis. In some embodiments, imaging data may be analyzed to determine whether at least a portion of the object containing the alphanumeric sequence is visible or has at least a threshold image quality. In an example, different images may include different portions of the object 135, and may be combined or considered in conjunction. In some embodiments, when one or more images fails to pass the image validation process, such images may be discarded. In some embodiments, e.g., in embodiments in which a portion of the alphanumeric sequence is not included in a remaining image, the validation process may further include obtaining one or more additional images, e.g., via extraction from a video, outputting a request to the user 160, etc. The request may include one or more recommendations or a reason why a previous image was discarded, e.g., an artifact, a perspective, a lighting condition, a focus, a closeness of the object 135 to the imaging device 150, etc.

At step 215, the user device 105 may perform an OCR process on the imaging data, e.g., to detect or identify a sequence of alphanumeric characters. Any suitable OCR process may be used.

At step 220, the user device 105 may determine, e.g., based on the OCR process, that the identified alphanumeric sequence is indeterminate, e.g., that the sequence includes at least one indeterminate character.

At step 225, the user device 105 may predict at least one value for the at least one indeterminate character. In some embodiments, the prediction is based on one or more of a predetermined syntax of the alphanumeric sequence or content of the image data separate from the alphanumeric sequence.

In an example, predicting the at least one value includes determining, based on the OCR process, a plurality of likely values for the at least one indeterminate character. For instance, the OCR process may be configured to output multiple possibilities for an indeterminate character. In an example, an OCR process may indicate that a particular character is likely to be one of a “1”, a “7”, an “I”, or an “l”.

In some embodiments, the user device 105 may be configured to evaluate the multiple possibilities using a predetermined syntax for the alphanumeric sequence, and select, as the at least one predicted value for the at least one indeterminate character, one of the multiple possibilities based on the evaluation with the predetermined syntax.

In an example, the alphanumeric sequence may be associated with a predetermined syntax such as a hashing, a checksum, or an algorithm such as a Luhn algorithm that is usable to determine whether a particular sequence is valid or not. For each possible value, the value may be inserted into the indeterminate sequence, which may then be evaluated using the algorithm or the like associated with the predetermined syntax. A positive result of the evaluation may correspond to a correct identification of the indeterminate character.

In some embodiments, the predetermined syntax to be used is specific to the task. For example, the user 160 may be scanning in an identification badge, in which identification numbers always adhere to a predetermined syntax associated with identification badges. In some embodiments, however, different predetermined syntaxes may pertain to different objects 135. For instance, the predetermined syntax that applies to a credit card may vary based on the issuer of the credit card. Thus, in some embodiments, the user device 105 may obtain context for the object 135 using content of the imaging data separate from the alphanumeric sequence. In an example, such content may include at least one identifying feature that is associated with an identity-specific predetermined syntax. In various embodiments, the predetermined syntax, e.g., a particular syntax associated with an object 135 such as an identity-specific predetermined syntax associated with an issuer of a particular credit card, may be obtained from one or more of a memory of the user device 105 or another source such as a server system 120, a provider system 110, or a third party system 125.

In a particular example, the user device 105 may employ an image analysis process or model to identify a name, logo, color, shape, expiration date, graphic, or other identifying feature associated with an object 135, may obtain a particular predetermined syntax based on the one or more identifying features, and then apply the particular predetermined syntax to evaluate the identification of the one or more indeterminate characters resulting from the OCR process.

In some instances, evaluating a sequence using one or more possible values may result in no indication of a valid sequence. In such instances, the user device 105 may, for example, obtain further imaging data of the object 135, e.g., by outputting request to the user 160.

In some instances, the evaluating of the sequence may result in a determination that the sequence is invalid. For example, information or context determined via evaluating content of the imaging data other than the sequence may conflict with one or more aspects of the sequence. In an example, the sequence itself may return as valid when evaluated with an algorithm, but the algorithm may conflict with the context. In a particular example, a particular algorithm may be usable to validate virtual credit card numbers, but is inapplicable to credit card numbers on physical cards. A presence of an expiration date in the other content of the imaging data, whereby virtual credit cards may not include an expiration date, may thus indicate that the sequence is likely fraudulent and thus invalid. In another example, a sequence that passes the Luhn algorithm may nonetheless be determined to be invalid due to a current date being beyond an expiration date present in the imaging data. In other examples, a coloring of the object 135 may be a color that was not produced by the issuer, a logo of the issuer may not be a version of the logo used by the issuer during a period in which the object 135 was issued (e.g., before its expiration), content from the imaging data may not match stored identifying features of the object 135 associated with the user 160, etc. Upon determining that the sequence, and thus the object 135, may be invalid, the user device 105 may transmit a notification to a remote system, such as the server system 120, the provider system 110, the third party system 125, etc. Such notification may be configured to block further use of the identified sequence, notify an account holder associated with the identified sequence, or the like.

In some embodiments, the OCR process may be configured to output likelihoods or confidences that an individual character in imaging data pertains to various possible identifications. For instance, the OCR process may indicate that a character in imaging data has an 35% confidence of being a “1” a 45% confidence of being an “I”, a 15% chance of being an “l”, and a 5% chance of being a “7”.

In some embodiments, the user device 105, e.g., instead of or in addition to the OCR process, may be configured to determine confidence scores for the various possible identifications based on one or more of the predetermined syntax or the content separate from the indeterminate alphanumeric sequence. For instance, a predetermined syntax may indicate that the character in the imaging data discussed above is a number and not a letter, or has a 90% likelihood of being a number rather than a letter, etc. An identification of the character may be selected based on the foregoing, e.g., based on the confidence score(s) or combinations thereof.

In some embodiments, confidence or likelihood scores may be compared against a predetermined confidence threshold. For example, a possible identification with a confidence below 20% may be pruned from the list of possible identifications, and a selection may be made from what remains.

In another example, predicting the at least one value is based on reflection pattern data of the alphanumeric sequence, e.g., as discussed in further detail below with regard to FIG. 3.

In some embodiments, a combination of techniques for predicting the one or more values for the one or more indeterminate characters may be used. In some embodiments, different techniques are performed sequentially or hierarchically. For example, in some embodiments, content of the imaging data other than the sequence may only be considered upon none of the confidence scores for possible identifications of an indeterminate character meeting the predetermined threshold. In an example, if the OCR process outputs that a character in imaging data has an 35% confidence of being a “1” a 45% confidence of being an “I”, a 15% chance of being an “l”, and a 5% chance of being a “7”. The predetermined confidence threshold may be 50%, such that none of the foregoing meet it. Upon none of the possibilities meeting the threshold, the other content of the imaging data may be used to identify a particular predetermined syntax requiring the character to be a number. Between the two remaining possibilities of “1” or “7”, the more confident possibility may be selected.

However, in another example in which a character is 95% likely to be a “5”, the identification may be selected without considering other content of the imaging data, since the 95% likelihood exceeds the predetermined threshold.

At step 230, the user device 105 may determine a complete alphanumeric sequence based on the at least one predicted value and the indeterminate alphanumeric sequence. In an example, the user device 105 may assemble the complete sequence by replacing the one or more indeterminate characters with one or more respective identifications.

At step 235, the user device may transmit the determined complete sequence to a remote device, e.g., the provider system 110, the server system 120, or the third party system 125. Such remote device may use the determined complete sequence to complete the action of the user 160, e.g., completing the interaction to obtain an item, validating an identification of the user 160, confirming physical possession of the object 135, etc. In some embodiments, the user device 105 may further output a visual indication of successful identification of the complete sequence.

In some embodiments, one or more of steps 210-235 may be performed remotely from the user device 105. For example, in an embodiment, the user device 105 may transmit the image data to a remote system such as the server system 120, which then performs the validation, image analysis, or the like. In some instances, such remote action may benefit from an increased computing power available to a remote system relative to the user device 105. However, in some embodiments, the time, bandwidth, or computing power needed to transmit such data may be undesirable. Thus, in some embodiments, such actions are performed locally, e.g., via a trained machine-learning model or algorithm that, although possibly complex or intensive to train, have a relatively low overhead at runtime and thus are able to operate on the user device 105.

FIG. 3 illustrates another exemplary process for leveraging completion logic. At step 305, imaging data may be obtained via the user device 105, e.g., via operation of the imaging device 150. Optionally, at step 310, the user device 105, e.g., the first or second electronic application or the like, may perform an image validation process. At step 315, the user device 105 may perform an OCR process on the imaging data, e.g., to detect or identify a sequence of three-dimensional alphanumeric characters. Any suitable OCR process may be used. At step 320, the user device 105 may determine, e.g., based on the OCR process, that the identified alphanumeric sequence is indeterminate, e.g., that the sequence includes at least one indeterminate three-dimensional character.

At step 325, e.g., upon determining that at least one three-dimensional character is indeterminate, the user device 105 may obtain reflective pattern data of the three-dimensional sequence.

In some embodiments, the reflective pattern data may be obtained using ambient lighting conditions, e.g., with a lighting device 155 of the user device 105 in an inactive state. However, in some instances, the user device 105 may determine that such unlit reflective pattern data was not sufficient to determine an identity for the at least one indeterminate three-dimensional character, e.g., via performing further steps of this method below. In such instances, the user device 105, in embodiments, may obtain or request further reflection pattern data in lit conditions. In some embodiments, the user device 105 may automatically activate the lighting device 155, e.g., before first obtaining the reflection pattern data or upon requesting or obtaining the further reflection pattern data. In some embodiments, the user device 105 may automatically deactivate the lighting device 155 upon the reflection pattern data or further reflection pattern data being obtained.

In some embodiments, the reflective pattern data includes one or more images that include reflective patterns. In some embodiments a plurality of images may be, acquired via the user device 150 from a plurality of different perspectives. For example, the obtaining of the plurality of images may occur as the user 160 moves or reorients the user device 105 or the object 135. In some embodiments, the user device 150 may output one or more instructions to the user 160 with regard to perspective or orientation for acquiring one or more images. In some embodiments, the user device 105 may determine a relative perspective of the user device to the indeterminate three-dimensional alphanumeric sequence on the object 135, and may output the one or more instructions based on the determined relative perspective. In some embodiments, the determination of the relative perspective is performed passively, e.g., independent of the capture of an image via the imaging device 155, such that images may be captured only at desired perspectives. In some embodiments, determining the relative perspective is based on one or more of image analysis of imaging data or one or more sensors of the user device 105 such as an accelerometer, gyroscope, near-field communication antenna, etc. In some embodiments, the user device 105 may be configured to request further reflection pattern data at a further perspective in response to determining, for example, that the at least one indeterminate three-dimensional character may not be identified using the perspective(s) of already obtained reflective pattern data.

At step 330, the user device 105 may predict at least one value for the at least one indeterminate three-dimensional alphanumeric character based on the reflective pattern data. In one example, predicting the at least one value includes performing an image comparison of at least one reflective pattern of the at least one indeterminate three-dimensional alphanumeric character and one or more reflective patterns of a known character. In some examples, possible options for the identity of the character have been narrowed down, e.g., via an OCR process, predetermined syntax, and or context, such as in one or more of the examples discussed above with regard to FIG. 2. For example, an OCR process may narrow down options for identifying a character to a “1” or an “I”, and comparison of a reflective pattern of the character with reflective patterns of “1”s and “I”s may reveal at least a likelihood that the character is a “1”.

In some embodiments, predicting the at least one value for the at least one three-dimensional alphanumeric character based on the reflective pattern data includes inputting the reflective pattern data into a trained machine-learning model configured to generate at least one prediction of a value in response to input of the reflective pattern data. In some embodiments, the trained machine-learning model may have been trained based on a plurality of reflective patterns and a plurality of values corresponding to the plurality of reflective patterns, e.g., so that the model has been trained to learn associations between reflective patterns and identities or values of characters. In some embodiments, the machine-learning model may be multi-model. For instance, the machine-learning model may have also been trained based on a plurality of images of three-dimensional alphanumeric characters corresponding to the plurality of reflective patterns, such that the trained machine-learning model is configured to generate the at least one prediction of a value in response to input of the reflective pattern data and the imaging data. In various embodiments, the machine-learning model may also be trained on one or more of predetermined syntax, context data such as identification of a card issuer or the like, or any other suitable data.

In some embodiments, data to be input into the machine-learning model may be encoded prior to input. For example, input image data, input reflection patter data, etc., may be encoded as an input tensor. In some embodiments, context data, such as described in one or more examples above, may be extracted or determined prior to use of the machine-learning model, such that such context data may also be included as input.

At step 335, the user device 105 may determine a complete alphanumeric sequence based on the at least one predicted value and the indeterminate alphanumeric sequence. In an example, the user device 105 may assemble the complete sequence by replacing the one or more indeterminate characters with one or more respective identifications. At step 340, the user device 105 may transmit the determined complete sequence to a remote device, e.g., the provider system 110, the server system 120, or the third party system 125.

It should be understood that any of the techniques described above may be combined, e.g., in parallel, sequentially, or hierarchically. For instance, reflective pattern data may only be used upon being unable to determine a character identity based on predetermined syntax, or vice versa. Context may only be considered upon the machine-learning model's output prediction being inconclusive. A confidence from the OCR process may be combined with an output confidence of the machine-learning model, e.g., as a weighted sum or multiplicatively or via any other suitable technique. The use of various techniques may be arranged based on time to execute or computing cost, e.g., such that fast or computationally cheap techniques are tried prior to techniques that may take longer to perform or require more computing resources. Doing so may reduce time and resources needed to identify a character.

It should be understood that embodiments in this disclosure are exemplary only, and that other embodiments may include various combinations of features from other embodiments, as well as additional or fewer features. For example, while some of the embodiments above pertain to identifying and capturing a credit card number or identification number, any suitable activity may be used. In an exemplary embodiment, instead of or in addition to using reflection pattern data, infrared or depth data may be used. In some instances, imaging devices 155 may be configured to capture light outside of the visual spectrum, which may include light in the infrared band. Reflections within the infrared band may be usable to acquire depth data, which may be used to evaluate three-dimensional structures in a manner similar to reflection pattern data.

In general, any process or operation discussed in this disclosure that is understood to be computer-implementable, such as the processes illustrated in FIGS. 2 and 3, may be performed by one or more processors of a computer system, such any of the systems or devices in the environment 100 of FIG. 1, as described above. A process or process step performed by one or more processors may also be referred to as an operation. The one or more processors may be configured to perform such processes by having access to instructions (e.g., software or computer-readable code) that, when executed by the one or more processors, cause the one or more processors to perform the processes. The instructions may be stored in a memory of the computer system. A processor may be a central processing unit (CPU), a graphics processing unit (GPU), or any suitable types of processing unit.

A computer system, such as a system or device implementing a process or operation in the examples above, may include one or more computing devices, such as one or more of the systems or devices in FIG. 1. One or more processors of a computer system may be included in a single computing device or distributed among a plurality of computing devices. A memory of the computer system may include the respective memory of each computing device of the plurality of computing devices.

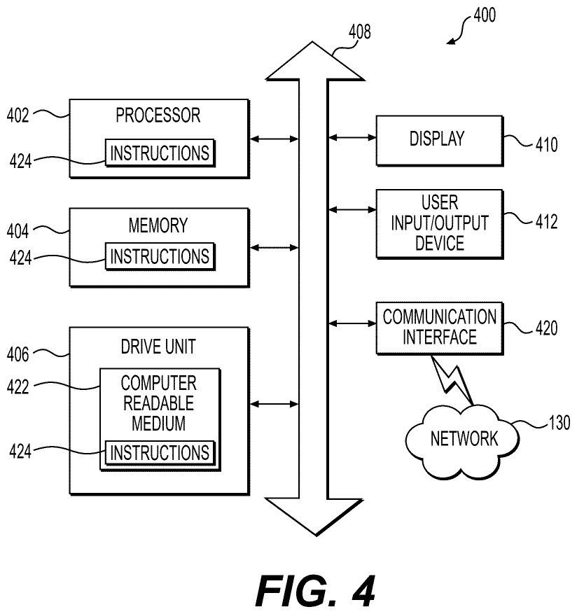

FIG. 4 is a simplified functional block diagram of a computer 400 that may be configured as a device for executing the methods of FIGS. 2 and 3, according to exemplary embodiments of the present disclosure. For example, the computer 400 may be configured as the user device 105, the server system 120, or another system according to exemplary embodiments of this disclosure. In various embodiments, any of the systems herein may be a computer 400 including, for example, a data communication interface 420 for packet data communication. The computer 400 also may include a central processing unit (“CPU”) 402, in the form of one or more processors, for executing program instructions. The computer 400 may include an internal communication bus 408, and a storage unit 406 (such as ROM, HDD, SDD, etc.) that may store data on a computer readable medium 422, although the computer 400 may receive programming and data via network communications. The computer 400 may also have a memory 404 (such as RAM) storing instructions 424 for executing techniques presented herein, although the instructions 424 may be stored temporarily or permanently within other modules of computer 400 (e.g., processor 402 or computer readable medium 422). The computer 400 also may include input and output ports 412 or a display 410 to connect with input and output devices such as keyboards, mice, touchscreens, monitors, displays, etc. The various system functions may be implemented in a distributed fashion on a number of similar platforms, to distribute the processing load. Alternatively, the systems may be implemented by appropriate programming of one computer hardware platform.

Program aspects of the technology may be thought of as “products” or “articles of manufacture” typically in the form of executable code or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

While the disclosed methods, devices, and systems are described with exemplary reference to transmitting data, it should be appreciated that the disclosed embodiments may be applicable to any environment, such as a desktop or laptop computer, an automobile entertainment system, a home entertainment system, etc. Also, the disclosed embodiments may be applicable to any type of Internet protocol.

It should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Thus, while certain embodiments have been described, those skilled in the art will recognize that other and further modifications may be made thereto without departing from the spirit of the invention, and it is intended to claim all such changes and modifications as falling within the scope of the invention. For example, functionality may be added or deleted from the block diagrams and operations may be interchanged among functional blocks. Steps may be added or deleted to methods described within the scope of the present invention.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations are possible within the scope of the disclosure. Accordingly, the disclosure is not to be restricted except in light of the attached claims and their equivalents.

What is claimed is:

1. A computer-implemented method for leveraging completion logic, the method comprising:
obtaining image data via a user device;
detecting, via optical character recognition (OCR), an indeterminate alphanumeric sequence in the image data, the indeterminate alphanumeric sequence including at least one indeterminate character;
predicting at least one value for the at least one indeterminate character based on one or more of a predetermined syntax of the alphanumeric sequence or content of the image data separate from the alphanumeric sequence; and
determining a complete alphanumeric sequence based on the at least one predicted value and the indeterminate alphanumeric sequence.

2. The computer-implemented method of claim 1, further comprising:
transmitting the determined complete alphanumeric sequence to a system remote from the user device.

3. The computer-implemented method of claim 1, wherein predicting the at least one value based on the predetermined syntax includes:
determining, based on the OCR, a plurality of likely values for the at least one indeterminate character;
for each value of the plurality of likely values, evaluating the predetermined syntax of the indeterminate alphanumeric sequence with the value applied; and
selecting the at least one predicted value from amongst the plurality of likely values based on the evaluating the predetermined syntax.

4. The computer-implemented method of claim 3, wherein the evaluating of the predetermined syntax includes applying a Luhn algorithm.

5. The computer-implemented method of claim 1, wherein:
the content of the image data separate from the alphanumeric sequence includes at least one identifying feature that is associated with an identity-specific predetermined syntax; and
predicting the at least one value based on the predetermined syntax includes obtaining, as the predetermined syntax, the identity-specific predetermined syntax associated with the at least one identifying feature.

6. The computer-implemented method of claim 5, wherein the at least one identifying feature includes at least one of an expiration date, a logo, a graphic, a color, or a company name.

7. The computer-implemented method of claim 1, further comprising:
evaluating the complete alphanumeric sequence based on the content of the image data separate from the alphanumeric sequence; and
determining, based on the evaluating of the complete alphanumeric sequence, that the complete alphanumeric sequence is invalid.

8. The computer-implemented method of claim 7, further comprising:
upon determining that the complete alphanumeric sequence is invalid, transmitting a notification to a system remote from the user device.

9. The computer-implemented method of claim 1, wherein predicting at least one value for the at least one indeterminate character includes:
determining, based on the OCR, a plurality of likely values for the at least one indeterminate character;
determining confidence scores for the plurality of likely values based on one or more of the predetermined syntax or the content separate from the indeterminate alphanumeric sequence; and
selecting the at least one predicted value from amongst the plurality of likely values based on the confidence scores.

10. The computer-implemented method of claim 9, wherein predicting at least one value for the at least one indeterminate character further includes:
comparing the confidence scores to a predetermined confidence threshold.

11. The computer-implemented method of claim 10, wherein the predicting at least one value for the at least one indeterminate character is only based on the content of the image data separate from the alphanumeric sequence in response to none of the confidence scores meeting the predetermined threshold.

12. A system for leveraging completion logic, the system comprising:
at least one memory storing instructions;
an imaging device; and
at least one processor operatively connected to the imaging device and at least one memory and configured to execute the instructions to perform operations, including;
obtaining image data via the imaging device;
detecting, via optical character recognition (OCR), an indeterminate alphanumeric sequence in the image data, the indeterminate alphanumeric sequence including at least one indeterminate character;
predicting at least one value for the at least one indeterminate character based on one or more of a predetermined syntax of the alphanumeric sequence or content of the image data separate from the alphanumeric sequence; and
determining a complete alphanumeric sequence based on the at least one predicted value and the indeterminate alphanumeric sequence.

13. The system of claim 12, wherein the operations further include:
transmitting the determined complete alphanumeric sequence to a further system remote from the system.

14. The system of claim 12, wherein predicting the at least one value based on the predetermined syntax includes:
determining, based on the OCR, a plurality of likely values for the at least one indeterminate character;
for each value of the plurality of likely values, evaluating the predetermined syntax of the indeterminate alphanumeric sequence with the value applied; and
selecting the at least one predicted value from amongst the plurality of likely values based on the evaluating the predetermined syntax.

15. The system of claim 14, wherein the evaluating of the predetermined syntax includes applying a Luhn algorithm.

16. The system of claim 12, wherein:
the content of the image data separate from the alphanumeric sequence includes at least one identifying feature that is associated with an identity-specific predetermined syntax;
the at least one identifying feature includes at least one of an expiration date, a logo, a graphic, a color, or a company name; and
predicting the at least one value based on the predetermined syntax includes obtaining, as the predetermined syntax, the identity-specific predetermined syntax associated with the at least one identifying feature.

17. The system of claim 12, wherein the operations further include:
evaluating the complete alphanumeric sequence based on the content of the image data separate from the alphanumeric sequence; and
determining, based on the evaluating of the complete alphanumeric sequence, that the complete alphanumeric sequence is invalid.

18. The system of claim 17, wherein the operations further include:
upon determining that the complete alphanumeric sequence is invalid, transmitting a notification to a further system remote from the system.

19. The system of claim 12, wherein predicting at least one value for the at least one indeterminate character includes:
determining, based on the OCR, a plurality of likely values for the at least one indeterminate character;
determining confidence scores for the plurality of likely values based on one or more of the predetermined syntax or the content separate from the indeterminate alphanumeric sequence;
comparing the confidence scores to a predetermined confidence threshold and
selecting the at least one predicted value from amongst the plurality of likely values based on the confidence scores and on the comparing.

20. A computer-implemented method for leveraging completion logic, the method comprising:
obtaining image data via a user device;
detecting, via optical character recognition (OCR), an indeterminate alphanumeric sequence in the image data, the indeterminate alphanumeric sequence including at least one indeterminate character;
determining, based on the OCR, confidence scores of a plurality of values for the at least one indeterminate character;
in response to none of the confidence scores meeting a predetermined threshold:
determining an identifying feature from the image data that is separate from the indeterminate alphanumeric sequence;
obtaining an identity-specific predetermined syntax associated with the identifying feature; and
predicting at least one value for the at least one indeterminate character based on the identity-specific predetermined syntax; and
determining a complete alphanumeric sequence based on the at least one predicted value and the indeterminate alphanumeric sequence.
